(19) United States
(12) Patent Application Publication
(10) Pub. No.: US 2010/0193976 A1
(43) Pub. Date: Aug. 5, 2010

(54) WATER MISTER FOR A HUMIDIFIER

(76) Inventor: Keng-U FANG, Tainan City (TW)

Correspondence Address: PATENTTM.US, P. O. BOX 82788, PORTLAND, OR, 97282-0788, US

(21) Appl. No.: 12/366,632

(22) Filed: Feb. 5, 2009

(51) Int. Cl. B01F 3/04

(52) U.S. Cl. 261/131; 261/81; 261/DIG. 48

(57) ABSTRACT

A water mister for a humidifier has a hollow base, a control assembly, and a diaphragm connected electrically to the control assembly. The hollow base has a tank formed therein and a heat-dissipating hole formed through the tank. The tank has a bottom and a diaphragm hole. The diaphragm hole is formed through the bottom of the tank. The control assembly has a chip. The chip is water-proof and mounted in the hollow base under and covers the heat-dissipating hole. Therefore, heat of the chip can be dissipated to the water in the tank. Because the water absorbs the heat of the chip, the heat can be dissipated quickly and efficiently.

### BACKGROUND OF THE INVENTION

1. Field of the Invention

The present invention relates to a water mister for a humidifier, and more particularly to a water mister that dissipates heat quickly and efficiently.

2. Description of Related Art

With reference to FIG. 6, a conventional water mister comprises a hollow base (90), an ultrasonic diaphragm (94) and a control assembly (95). The hollow base (90) has a tank (91) formed on the hollow base (90) and a mounting board (92). The tank (91) has a bottom and a mount hole formed on the bottom, and may further have a level sensor (98) mounted in the tank (91). The mounting board (92) is mounted under the mount hole and has a hole (93) and a portion protruding through the mount hole. The hole (93) of the mounting board (92) is formed through the portion. With further reference to FIG. 7, the ultrasonic diaphragm (94) is mounted under the mounting board (92) over the hole (93) of the mounting board (92). The control assembly (95) is mounted in the hollow base (90) and has a Printed Circuit Board (PCB, 96) and a chip (97) electrically connected to the PCB (96). The PCB (96) is electrically connected with the ultrasonic diaphragm (94). With further reference to FIG. 8, the chip (97) is mounted under the mounting board (92) in the hollow base (90).

While the conventional water mister is in use, the ultrasonic diaphragm (94) vibrates at an ultrasonic frequency via the control assembly (95) and creates water droplets that exit the tank (91) in the form of a cool mist. However, heat accumulates on the chip (97) and is dissipated to the water by the mounting board (92) by the thermal conductivity of the mounting board (92). If the heat cannot be dissipated, the chip (97) will lose efficacy and affect the vibration of the ultrasonic diaphragm (94).

For good thermal conductivity, the mounting board (92) is often made of metal. However, the mounting board (92) might rust, especially when the level sensor (98) measures water level by transmitting current. Once the mounting board (92) rusts, people may doubt a purity of the water and mist so are deterred from using the water mister.

To overcome the shortcomings, the present invention provides a water mister to mitigate or obviate the aforementioned problems.

### SUMMARY OF THE INVENTION

The main objective of the invention is to provide a water mister that dissipates heat quickly and efficiently.

A water mister for a humidifier has a hollow base, a control assembly, and a diaphragm connected electrically to the control assembly. The hollow base has a tank formed therein and a heat-dissipating hole formed through the tank. The tank has a bottom and a diaphragm hole. The diaphragm hole is formed through the bottom of the tank. The control assembly has a chip. The chip is water-proof and mounted in the hollow base under and covers the heat-dissipating hole. Therefore, heat of the chip can be dissipated to the water in the tank. Because the water absorbs the heat of the chip, the heat can be dissipated quickly and efficiently.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a water mister for a humidifier in accordance with the present invention;

FIG. 2 is a side view in partial section taken along line 2-2 of the water mister in FIG. 1;

FIG. 3 is a top view of a second embodiment of the water mister in accordance with the present invention;

FIG. 4 is a side view in partial section taken along line 4-4 of the water mister in FIG. 3;

FIG. 5 is a side view in partial section taken along line 5-5 of the water mister in FIG. 3;

FIG. 6 is a top view of a conventional water mister;

FIG. 7 is a side view in partial section taken along line 7-7 of the conventional water mister in FIG. 6; and

FIG. 8 is a side view in partial section taken along line 8-8 of the conventional water mister in FIG. 6.

### DETAILED DESCRIPTION OF PREFERRED EMBODIMENT

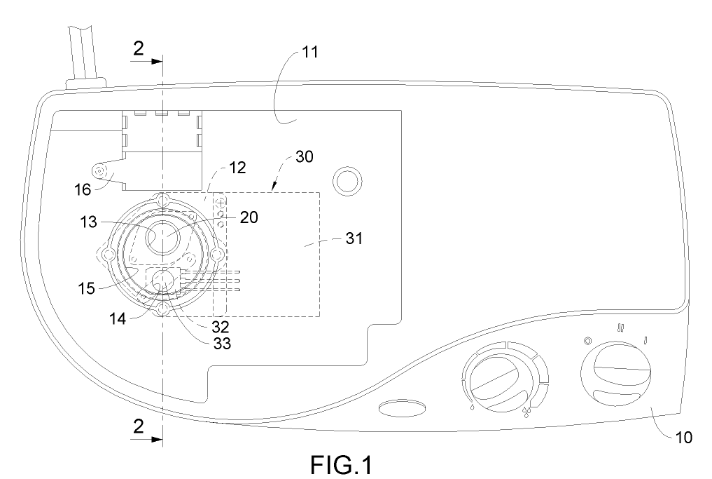

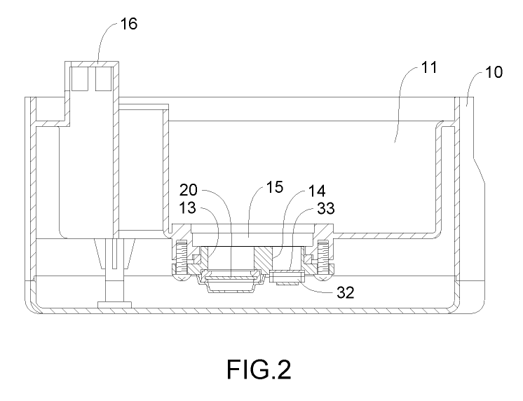

With reference to FIGS. 1 and FIG. 2, the water mister for a humidifier comprises a hollow base (10), a control assembly (30) and a diaphragm (20).

The hollow base (10) has a tank (11), a mounting board (12) and a heat-dissipating hole (14), and may further have a level sensor (16). The tank (11) is formed in the hollow base (10) and has a bottom and a mount hole (15) formed through the bottom.

The mounting board (12) is mounted under and covers the mount hole (15), and has a surface and a diaphragm hole (13) formed through the surface.

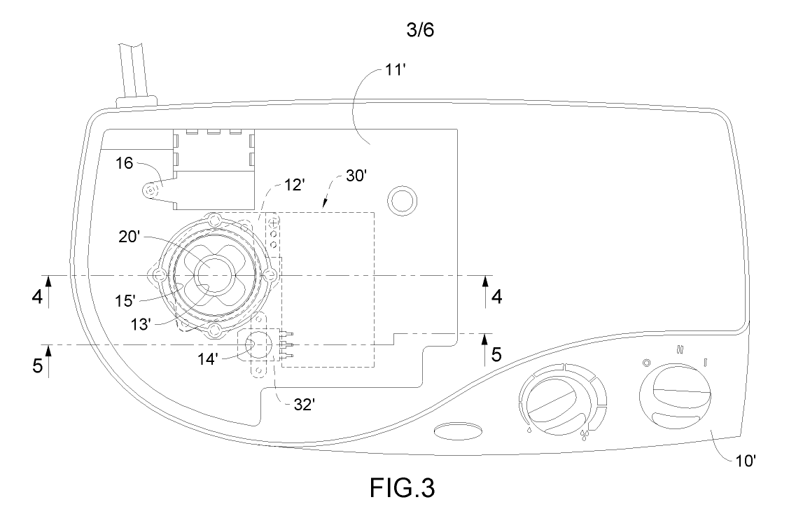

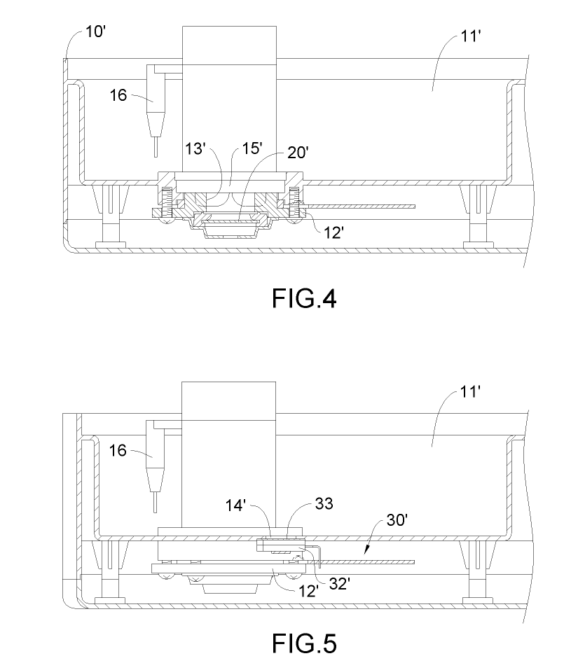

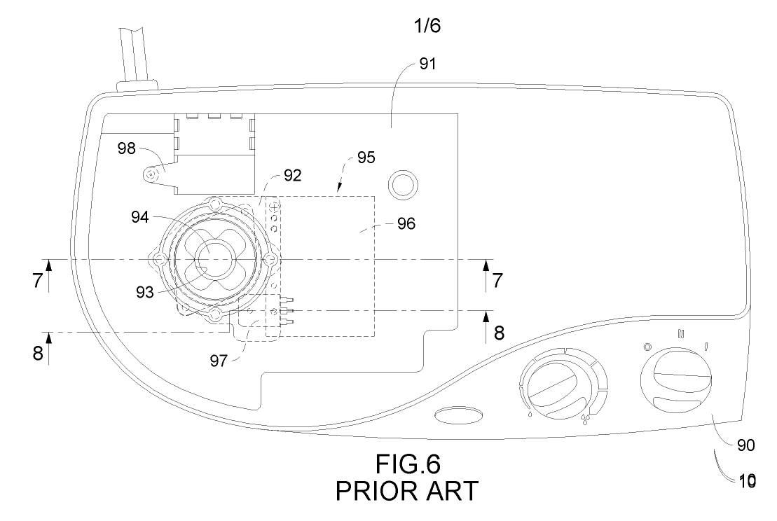

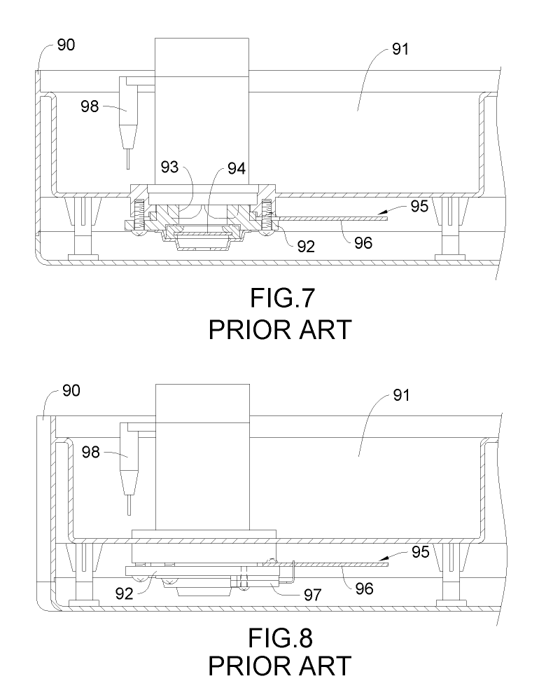

With further reference to FIGS. 3, 4 and 5, the heat-dissipating hole (14, 14′) is formed through the surface of the mounting board (12, 12′) and communicates with the mount hole (15, 15′) or may be formed through the bottom of the tank (11, 11′).

The control assembly (30, 30′) is mounted in the hollow base (10, 10′) and has a printed circuit board (PCB) (31) and a chip (32, 32′), and may further have a waterproof membrane (33) and actuators for external control. The PCB (31) is mounted in the hollow base (10, 10′). The chip (32, 32′) is water-proof, is electrically connected to the PCB (31), is mounted under and covers the heat-dissipating hole (14, 14′). The chip (32, 32′) has a side and a high-temperature portion. The high-temperature portion of the chip (32,32′) aligns with the heat-dissipating hole (14, 14). The waterproof membrane (33) is thermal conductive and is mounted over the chip (32, 32′), covers the high-temperature portion and prevents water from moistening and affecting the control assembly (30, 30′). The actuators of the control assembly (30, 30′) may be automatically or manually controlled and may comprise a percentage humidity control, a flow control, a faucet control and the like and may be integrated in a digital control panel. The digital control panel may comprise a humidity sensor.

The diaphragm (20, 20′) is electrically connected to the control assembly (30, 30′) via the PCB (31) and mounted under and covers the diaphragm hole (13, 13′) of the mount hole (15, 15′). The diaphragm (20, 20′) has a vibrate center and the vibrate center aligns with the diaphragm hole (13, 13′).

The level sensor (16) is mounted in the tank (11, 11′) and detects a water level and may be connected to the control assembly (30, 30′).

To humidify air, water is added to the tank (11, 11 ′) of the base (10, 10′) and enters the diaphragm hole (13, 13′) and the heat-dissipating hole (14, 14′). The level sensor (16) determines the water level to notify people of the water level and signal the control assembly (30, 30′) to actuate the faucet to open or close accordingly. The diaphragm (20, 20′) vibrates to create droplets, which form mist for humidifying and cooling.

When activated, the chip (32, 32′) produces heat, which is dissipated through the waterproof membrane (33) directly to the water. Because of the temperature difference between water and the chip (32, 32′), heat is efficiently conducted to the water from the chip (32, 32′). Further, the mounting board (12, 12′) may be plastic or other insulating materials for reduced production cost and prevent water discoloration associated with rusting.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A water mister for a humidifier comprising:
a hollow base having
a tank being formed in the hollow base and having
a bottom; and
a mount hole being formed through the bottom; and
a mounting board being mounted under and covering the mount hole and having
a surface being adjacent to the mount hole; and
a diaphragm hole being formed through the surface and communicating with the mount hole of the tank;
a heat-dissipating hole being formed through the surface of the mounting board and communicating with the mount hole of the tank;
a control assembly being mounted in the hollow base and having
a printed circuit board (PCB) being mounted in the hollow base; and
a chip being electrically connected to the PCB, being water-proof, being mounted under and covering the heat-dissipating hole; and
a diaphragm being electrically connected to the control assembly and mounted under and covering the diaphragm hole of the mounting board.

2. The water mister as claimed in claim 1, wherein the chip has a side adjacent to the heat-dissipating hole; and
the control assembly further has a waterproof membrane being thermal conductive and mounted over the side of the chip.

3. The water mister as claimed in claim 1, wherein the base further has a level sensor being mounted in the tank.

4. The water mister as claimed in claim 2, wherein the base further has a level sensor being mounted in the tank.

5. A water mister for a humidifier comprising:
a hollow base having
a tank being formed in the hollow base and having
a bottom; and
a mount hole being formed on the bottom;
a mounting board being mounted under and covering the mount hole and having
a surface being adjacent to the mount hole; and
a diaphragm hole being formed through the surface and communicating with the mount hole of the tank; and
a heat-dissipating hole being formed through the bottom of the tank;
a control assembly being mounted in the hollow base and having
a printed circuit board (PCB) being mounted in the base; and
a chip being electrically connected to the PCB, being water-proof, being mounted under and covering the heat-dissipating hole; and
a diaphragm being electrically connected with the control assembly and mounted under and covering the diaphragm hole of the mounting board.

6. The water mister as claimed in claim 5, wherein the chip has a side adjacent to the heat-dissipating hole; and
the control assembly further has a waterproof membrane being thermal conductive and mounted over the side of the chip.

7. The water mister as claimed in claim 5, wherein the base further has a level sensor being mounted in the tank.

8. The water mister as claimed in claim 6, wherein the base further has a level sensor being mounted in the tank.
